(19) United States
(12) Patent Application Publication
(10) Pub. No.: US 2002/0025463 A1
(43) Pub. Date: Feb. 28, 2002

(54) Fuel cell system

(76) Inventors: Monika Derflinger, Neidlingen (DE); Isabel Haas, Kirchheim (DE); Lars Kaufmann, Kirchheim (DE)

Correspondence Address: CROWELL & MORING LLP, P. O. Box 14300, Washington, DC, 20044-4300, US

(21) Appl. No.: 09/898,468

(22) Filed: Jul. 5, 2001

(30) Foreign Application Priority Data
Jul. 5, 2000 (DE) 100 32 667.6

(51) Int. Cl. H01M 8/06

(52) U.S. Cl. 429/19; 429/34; 429/17

(57) ABSTRACT

A fuel cell system has a fuel cell unit with at least one fuel cell and a gas generation system for generating a hydrogen-rich medium which is supplied to the fuel cell unit. In the case of a single-stage oxidation unit, a first separator for separating water out of the hydrogen-rich medium is provided upstream of the single stage, and a pressure-reducing valve is provided between the first separator and the stage. In the case of a multistage oxidation unit, a first separator for separating water out of the hydrogen-rich medium is provided upstream of the final stage of the oxidation unit, and a pressure-reducing valve is provided between the first separator and the final stage.

### BACKGROUND AND SUMMARY OF THE INVENTION

This application claims the priority of German patent document 100 32 667.6, filed Jul. 5, 2000, the disclosure of which is expressly incorporated by reference herein.

The invention relates to a fuel cell system having a gas generation unit for supplying a fuel rich medium to a fuel cell.

Water balance plays an important role in a fuel cell system with PEM fuel cells, particularly systems in which hydrogen for operating the fuel cell is provided by means of a reforming process. However, when the fuel cell system is used for mobile applications, it is impractical to carry large quantities of water to wet the system, and it is therefore important to recover as much water as possible from the system. A system of this type is described, for example, in German patent document DE 197 07 814 C1, in which water generated during the electrochemical reaction of hydrogen and oxygen in the fuel cell is reused for the reforming process.

Deionized water and a medium which contains carbon and hydrogen (for example methanol), are mixed, evaporated and converted into hydrogen and carbon dioxide by the reforming process. The hydrogen is fed to the fuel cell, which converts it, together with oxygen, into electrical energy and water in a catalytic process.

International patent document WO 99/60646 A1 discloses a fuel cell system in which water is obtained by condensing and separating it from the cathode and anode exhaust gas streams of the fuel cell. An oxidation unit for oxidizing carbon monoxide (into which water is sprayed for reaction and for cooling of the hydrogen-rich product gas) and a condenser which removes the steam from the hydrogen-rich product gas and cools it further before it enters the fuel cell, are connected between a reforming unit and the fuel cell.

One object of the present invention is to provide a fuel cell system which has an improved water balance.

This and other objects and advantages are achieved by the fuel cell system and method according to the invention, which includes a gas generation system for generating a hydrogen-rich medium to supply the fuel cell unit with hydrogen. The gas generation system has a pressure-reducing valve situated between a first separator for separating water out of the hydrogen-rich medium and the final stage of an oxidation unit.

The advantage of this arrangement is that more water can be separated out of the hydrogen-rich medium by the separator at high pressure, so that recovery of the water contained in the system is improved. A further advantage is that the flows of media are dried in the region of the fuel cell unit, so that the system components are better protected from filling up with water.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of a preferred embodiment for carrying out the invention.

### DETAILED DESCRIPTION OF THE DRAWINGS

The device is particularly suitable for fuel cell systems in mobile units, such as for example fuel cell vehicles.

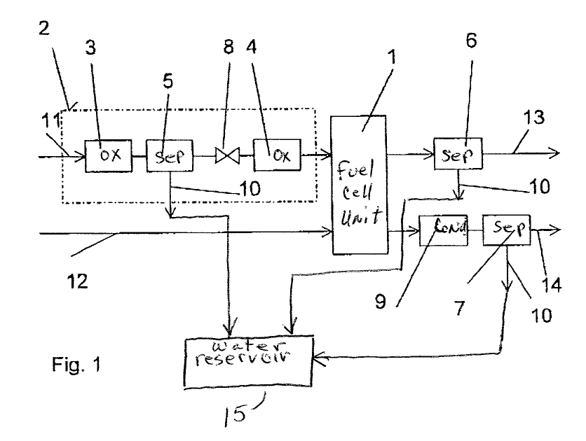

FIG. 1 shows a preferred arrangement of a fuel cell system according to the invention, which has a fuel cell unit 1 with at least one fuel cell having an anode space and a cathode space separated by a proton-conducting membrane. Upstream of the fuel cell is an anode supply line 11 for supplying a hydrogen-rich medium to the anode space and a cathode supply line 12 for supplying an oxygen-rich medium to the cathode space of the fuel cell unit 1. A gas generation system 2, only part of which is illustrated in the figure, is arranged in the anode supply line 11. A hydrogen-rich medium which serves as fuel for the fuel cell unit 1 is obtained from a hydrogen-containing medium in the gas generation system 2. The gas generation system 2 includes at least one reforming reactor and a gas cleaning unit which is provided for the purpose of removing undesirable carbon monoxide from the reformate.

The gas cleaning unit has an oxidation unit which has at least one stage and in which carbon monoxide is oxidized to form carbon dioxide. Two stages 3, 4 of a multistage oxidation unit are shown in the figure. A first separator 5 is provided between the final stage 4 and the penultimate stage 3 of the oxidation unit. In the case of a single-stage oxidation unit, the first separator would be arranged upstream of the single stage of the oxidation unit.

A pressure-reducing valve is provided between the first separator 5 and the final stage 4 of the multistage oxidation unit, so that the hydrogen-rich medium in the anode supply line 11 is exposed to a higher pressure p1 in the previous stages of the oxidation unit and the first separator 5 than in or after the final stage 4 of the oxidation unit. At higher pressure, the saturation vapour pressure of water is lower than at lower pressure. This leads to less steam but more liquid water and/or water droplets being entrained in the hydrogen-rich medium.

The first separator 5, which is situated upstream of the fuel cell unit 1 serves as a water separation unit, and substantially represents a vessel in which liquid water and water drops are separated out of the flow of medium. This can take place without further measures such as cooling of the medium. However, it is also possible for a reformate cooler to be connected upstream for cooling purposes. On the other hand, with a condenser a humid medium is cooled, so that water in vapour form which is contained in the medium condenses out and is then separated out in the downstream separator.

A second separator 6 is arranged downstream of the fuel cell unit 1, in an anode exhaust gas stream 13 and removes entrained water from this stream and discharges it from the separator 6 via a discharge line 10.

A third separator 7 is arranged in the cathode exhaust gas stream 14. A condenser 9 is provided upstream of the third separator 7, in order to cool the cathode exhaust gas. Some of the steam entrained in this gas condenses and can be separated out from the cathode exhaust gas in the third separator 7. The water collected is discharged from the separator 7 via a further discharge line 10.

It is advantageous for the water collected in the separators 5, 6, 7 to be discharged into a common collection vessel 15 and to be made available again to the gas generation system 2 and/or the fuel cell unit 1 and/or other components of the fuel cell system. For this purpose, it is also possible for the recovered water to be cleaned before being made available.

It is particularly preferable to use an oxidation unit with four stages, in which the first separator 5 is provided between the third and fourth stages of the oxidation unit. The oxidation unit is particularly preferably a unit for the selective oxidation of carbon monoxide.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system having a fuel cell unit with at least one fuel cell and a gas generation system for generating a hydrogen-rich medium to supply the fuel cell unit with hydrogen, the gas generation system having an oxidation unit for converting carbon monoxide into carbon dioxide, and a water separation unit upstream of the fuel cell unit for removing water from the hydrogen-rich medium, wherein one of the following is true:
the oxidation unit is a single-stage oxidation unit, with a first separator for separating water out of the hydrogen-rich medium provided upstream of the single stage, and a pressure-reducing valve provided between the first separator and the single stage; and
the oxidation unit is a multistage oxidation unit, with a first separator for separating water out of the hydrogen-rich medium provided upstream of a final stage of the oxidation unit, and a pressure-reducing valve provided between the first separator and the final stage.

2. The fuel cell system according to claim 1, wherein the oxidation unit comprises a four-stage structure.

3. The fuel cell system according to claim 1, further comprising a second separator for separating water out of an anode exhaust gas stream, provided downstream of the fuel cell unit in an anode exhaust gas stream.

4. The fuel cell system according to claim 1, further comprising a third separator for separating water out of a cathode exhaust gas stream, provided downstream of the fuel cell unit in a cathode exhaust gas stream.

5. The fuel cell system according to claim 4, further comprising a condenser for condensing steam out of a cathode exhaust gas stream, provided between the fuel cell unit and the third separator.

6. The fuel cell system according to claim 1, wherein the first separator is provided between third and fourth stages of the oxidation unit.

7. The fuel cell system according to claim 1, wherein separated water is fed to a water reservoir.

8. A method for operating a fuel cell system having a fuel cell unit with at least one fuel cell and a gas generation system for generating a hydrogen-rich medium to supply the fuel cell unit with hydrogen, the gas generation system having an oxidation unit for converting carbon monoxide into carbon dioxide, and a water separation unit upstream of the fuel cell unit for removing water from the hydrogen-rich medium, wherein one of the following is true:
the oxidation unit is a single-stage oxidation unit, with a first separator for separating water out of the hydrogen-rich medium provided upstream of the single stage, and a pressure-reducing valve provided between the first separator and the single stage; and
the oxidation unit is a multistage oxidation unit, with a first separator for separating water out of the hydrogen-rich medium provided upstream of the final stage of the oxidation unit, and a pressure-reducing valve provided between the first separator and the final stage; wherein said method comprises:
separating water out of a hydrogen-rich medium in an anode supply line in a region of first pressure, which is higher than a second pressure at which the hydrogen-rich medium is introduced into the fuel cell unit.

9. The method according to claim 8, wherein liquid water is separated out of an anode exhaust gas stream.

10. The method according to claim 8, wherein liquid water is separated out of a cathode exhaust gas stream.

11. The method according to claim 10, wherein the cathode exhaust gas stream is cooled via a condenser before the water is separated out.
